(19) United States
(12) Patent Application Publication
(10) Pub. No.: US 2017/0217015 A1
(43) Pub. Date: Aug. 3, 2017

(54) INDUSTRIAL ROBOT

(71) Applicant: HIWIN MIKROSYSTEM CORP., Taichung City (TW)

(72) Inventors: Jhong - Siang LIOU, Taichung City (TW); Chien-Nien TSAI, Taichung City (TW); Li-Wei ZHENG, Taichung City (TW); Yu-Hsiang LIN, Taichung City (TW); Tzu-Hsiang Hung, Taichung City (TW)

(21) Appl. No.: 15/011,048

(22) Filed: Jan. 29, 2016

(51) Int. Cl. B25J 9/12

(52) U.S. Cl. CPC B25J 9/123

(57) ABSTRACT

An industrial robot includes an actuator and a driver. The actuator serves to provide power inside so as to create a predetermined motional form. The driver serves to drive an internal power source of the actuator to output power. The driver is adjacently and fixedly connected with one end of the actuator. A power unit is disposed in the actuator for generating power. The power unit has an output shaft. The actuator has a transmission unit for transmitting the power to make an operation unit move in the predetermined motional form. The transmission unit has a transmission shaft. The output shaft and the transmission shaft are coaxially and integrally formed.

### BACKGROUND OF THE INVENTION

1. Field of the Invention

The present invention relates generally to a transmission device, and more particularly to an industrial robot.

2. Description of the Related Art

A robot generally includes components of a control system, a driver, a motor and a transmission system. The control system serves to perform intelligent calculation and give control command to the driver. According to the control command, the driver serves to drive the motor to output power. The transmission system serves to transmit the power outward to create a predetermined motion. Such industrial robot has been widely and practically applied to various fields. However, it is quite complicated to manufacture and process the industrial robot and the necessary mechanical and electrical connection components of the industrial robot may affect the reliability of transmission and the effective utilization of the space. In addition, the conventional driver is generally arranged at a remote end. Therefore, in the practical operation space immediately adjacent to the transmission system, an operator can hardly real-time know the state of the practical operation and can know the state only from the control system at the remote end. As a result, the real-time effect and the convenience of control of such industrial robot are both poor.

### SUMMARY OF THE INVENTION

It is therefore a primary object of the present invention to provide an industrial robot, in which the driver, the power unit and the transmission unit are integrated to reduce the number of the connection components, lower the complexity of the assembling process, reduce the number of the laid wires and simplify/minify the total volume of the industrial robot.

To achieve the above and other objects, the industrial robot of the present invention includes an actuator and a driver. The actuator serves to provide power inside so as to create a predetermined motional form. The driver serves to drive an internal power source of the actuator to output power. The driver is adjacently and fixedly connected with one end of the actuator. A power unit is disposed in the actuator for generating power. The power unit has an output shaft. The actuator has a transmission unit for transmitting the power to make an operation unit move in the predetermined motional form. The transmission unit has a transmission shaft coaxially and integrally formed with the output shaft.

In the above industrial robot, the relative connection position between the driver and the actuator can be changed in accordance with the application requirements of different industries. Accordingly, the actuator further includes a seat member on which the power unit and the transmission unit are disposed. The driver is adjacently connected with one end of the seat member opposite to the axial direction of the output shaft.

Accordingly, in the relative space position between the respective components, the connection between the driver and the actuator can be conveniently adjusted to position the power unit between the driver and the transmission unit or position the transmission unit between the driver and the power unit in accordance with the change of the conditions of the practical application.

In addition, in the above industrial robot, the actuator further includes a feedback unit for detecting the motional displacement and giving a feedback to an external control system so as to control the operation of the robot.

The feedback unit serves to detect the geometrical displacement of the transmission shaft of the transmission unit or the geometrical displacement of the output shaft of the power unit or the geometrical displacement of the operation unit.

More specifically, the power unit is a motor and the transmission shaft of the transmission unit is a threaded rod. After the power unit converts electrical energy into mechanical energy, the integrally formed output shaft can directly drive the transmission shaft to rotate in a located and restricted state. Accordingly, the operation can reciprocally and linearly move in the axial direction of the transmission shaft.

In addition, in order to provide real-time signal display function for the industrial robot in the practical application, different visible lights and specific lighting manners can be used to achieve the effect of transmission of different information. To achieve this, the driver further includes a case fixedly disposed at one end of the seat member. Multiple electrical connection wires extend from the interior of the case to outer side of the case. At least one control button is disposed within the case. A light source is disposed in the case for emitting light through the control button.

The present invention can be best understood through the following description and accompanying drawings, wherein:

### BRIEF DESCRIPTION OF THE DRAWINGS

FIG. 1 is a perspective view of a first embodiment of the present invention;

FIG. 2 is a perspective view of a part of the first embodiment of the present invention;

FIG. 3 is a sectional view of the first embodiment of the present invention, taken along line 3-3 of FIG. 1;

FIG. 4 is a perspective view of a second embodiment of the present invention;

FIG. 5 is a perspective view of a third embodiment of the present invention; and

FIG. 6 is a perspective view of a fourth embodiment of the present invention.

### DETAILED DESCRIPTION OF THE PREFERRED EMBODIMENTS

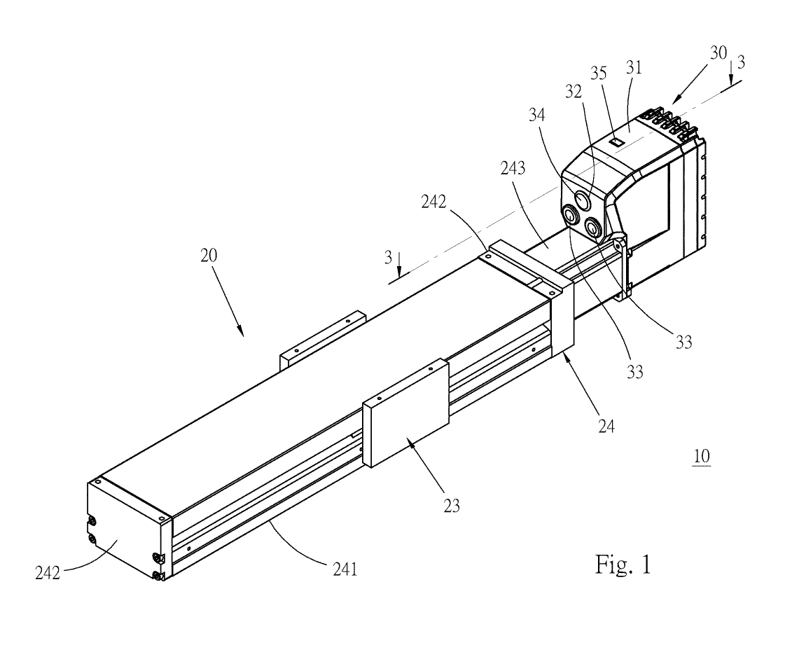

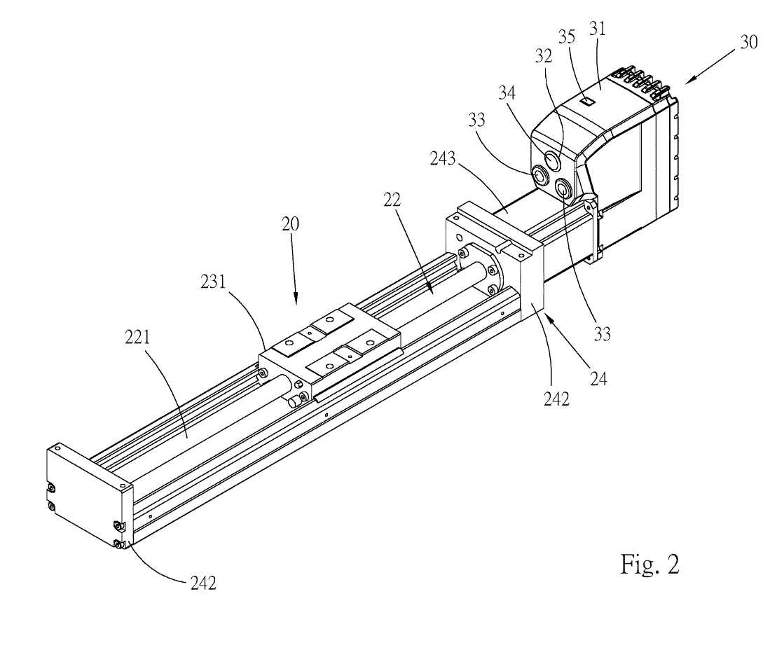

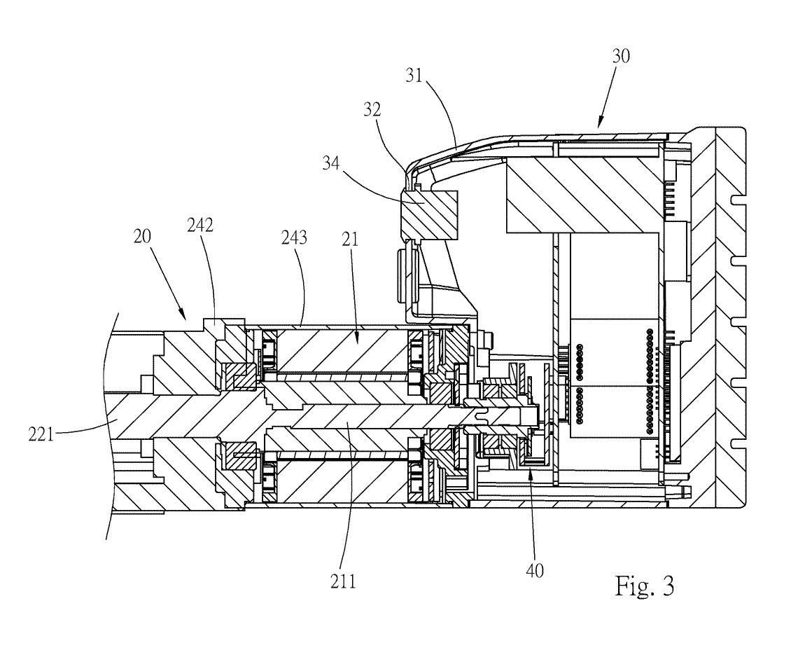

Please refer to FIGS. 1 to 3. According to a first embodiment, the industrial robot 10 of the present invention is a single-shaft industrial robot, mainly including an actuator 20 and a driver 30.

The actuator 20 has a power unit 21 for generating power, a transmission unit 22 for transmitting power, an operation unit 23 movable linearly and reciprocally, and a seat member 24 on which the above components are disposed.

The seat member 24 has a guide seat 241 in a rectangular form. The guide seat 241 provides guiding effect in a direction parallel to the lengthwise direction for guiding the operation unit 23 linearly and reciprocally. The seat member 24 further has two pier seats 242 respectively disposed at two lengthwise ends of the guide seat 241 and spaced from each other. The transmission unit 22 is disposed on the pier seats 242. The seat member 24 further has a case seat 243 fixedly at one of the two lengthwise ends of the guide seat 241. The power unit 21 is disposed in the case seat 243.

The power unit 21 is a conventional motor for converting electrical energy into mechanical energy. The transmission unit 22 serves to transmit the mechanical energy to activate the operation unit 23. The stator and the rotor of the power unit 21 are held in the case seat 243 and disposed on the seat member 24 with the transmission unit 22 and the operation unit 23.

The transmission unit 22 can be a threaded rod, a ball threaded rod or the like mechanism for converting rotational motion into linear motion. Two ends of the threaded rod are bridged and rotatably located on the pier seats 242.

The operation unit 23 can be a conventional linear slide rail. The operation unit 23 has a slide seat 231 screwed on the transmission unit 22 and slidably connected with the guide seat 241.

The power unit 21 has a rod-shaped output shaft 211 for outputting mechanical energy. The transmission unit 22 in the form of a threaded rod or a ball threaded rod (the spiral groove is not shown) has a transmission shaft 221 coaxially and integrally formed with the output shaft 211 as a one-piece component. Accordingly, the power output from the output shaft 211 of the power unit 21 can be directly transmitted outward via the transmission shaft 221 without using a connection member such as a shaft coupler. In addition, the driver 30 is directly adjacently connected with one end of the seat member 24 opposite to the linear moving direction of the operation unit 23. As shown in the drawings, the driver 30 is fixedly connected on the case seat 243 with the power unit 21 positioned between the transmission unit 22 and the driver 30. Accordingly, the actuator 20 and the driver 30 are integrated as a whole simply to reduce the number of the modules, minify the volume and enhance the reliability and performance such that the wire layout and assembling steps can be reduced in practical application. Also, the installation size of the mechanism of the present invention is compatible with the conventional design to meet the strict requirements of automation, layout and space utilization.

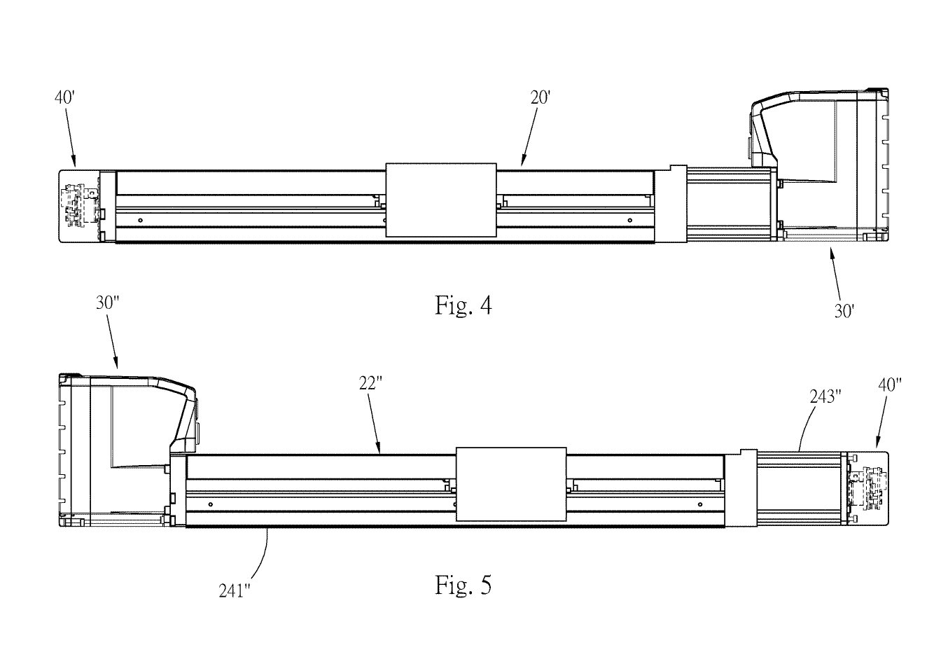

More specifically, in accordance with the requirement of control system, a proper sensation or feedback system is needed for the mechanical displacement of the robot. The sensation technique has been considerably disclosed in prior art and is not further described hereinafter. Any feedback unit is applicable to the present invention for detecting the geometrical displacement of the output shaft 211 of the power unit 21 in rotation, for detecting the geometrical displacement of the transmission shaft 221 of the transmission unit 22 in rotation or for detecting the geometrical displacement of the slide seat 231 of the operation unit 23 in linear reciprocal motion. Refer to FIG. 4, FIG. 4 shows that a feedback unit 40 is connected with an end of the output shaft 211 of the power unit 21 opposite to the transmission shaft 221 for detecting the geometrical displacement of the output shaft 211. In addition, visually distinguishable signals are provided for an operator to directly recognize the operation state of the robot in the operation environment. Accordingly, in this embodiment, the driver 30 has a case 31 adjacently and fixedly disposed on the seat member 24. A hole 32 is formed through the case 31. Two perforations 33 are formed through the case 31 for external cables to extend there through so as to electrically connect the devices inside and outside the case 31. At least one control button 34 is slidably disposed within the hole 32. One end of the control button 34 is exposed to outer side as an interface for an operator. A light source (not shown) is disposed within the case 31. The light emitted from the light source is transmitted outward through the control button 34. Accordingly, different operation states can be shown to the operator via different visible lights or different lighting manners. For example, the color of the light can be changed to represent different states or modes. Also, the number of the times at which the control button 34 is pressed can be changed or the duration by which the control button 34 is pressed can be changed to switch the functions. Moreover, the operator can clearly know whether the execution has been completed via the color of the light or the flickering feedback of the light.

The driver 30 can include a signal transmission device 35 for connection and data transmission to provide adjustment and correction of the driver 30. In this embodiment, the signal transmission device 35 is, but not limited to, a universal serial bus (USB). In other embodiments, the signal transmission device 35 can be alternatively a connector with terminals.

In conclusion, in the industrial robot of the present invention, the output shaft and the transmission shaft are integrally formed. Also, the driver and the actuator are integrally connected to create more available space for flexible application.

FIG. 4 shows a second embodiment of the present invention. The substantial adjustment is performed in such a manner that the actuator 20′ is positioned between the feedback unit 40′ and the driver 30. The feedback unit 40′ is disposed at one end of the transmission unit 22′ distal from the power unit for detecting the geometrical displacement of the transmission unit 22.

FIG. 5 shows a third embodiment of the present invention. In this embodiment, the driver 30″ is adjacently and fixedly disposed at the other lengthwise end of the guide seat 241′. That is, the driver 30″ and the case seat 243″ are respectively uprightly disposed at two lengthwise ends of the guide seat 241′. However, the feedback unit 40″ is kept arranged in the same manner as the first embodiment. Therefore, the transmission unit 22″ is positioned between the power unit and the driver 30″.

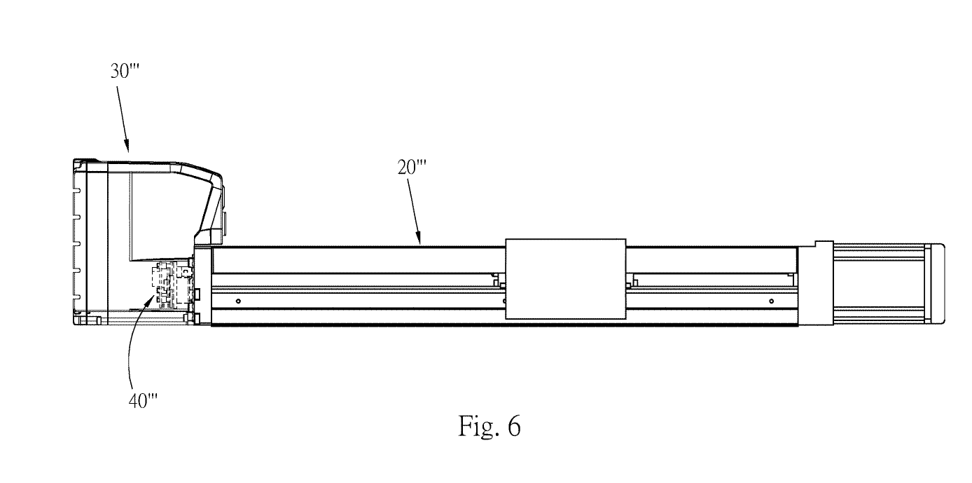

FIG. 6 shows a fourth embodiment of the present invention. In this embodiment, the feedback unit 40′″ is arranged in the same manner as the second embodiment, while the driver 30′″ is arranged in the same manner as the third embodiment. Accordingly, the driver 30′″ and the feedback unit 40′″ are positioned at one end of the actuator 20′″ distal from the power unit.

The above embodiments are only used to illustrate the present invention, not intended to limit the scope thereof. Many modifications of the above embodiments can be made without departing from the spirit of the present invention.

What is claimed is:

1. An industrial robot comprising:
an actuator having a power unit for generating power, an operation unit moved linearly and reciprocally and a transmission unit for transmitting the power from the power unit to the operation unit; and
a driver electrically connected with the power unit for driving the power unit;
wherein the actuator further includes a seat member on which the power unit, the transmission unit and the operation unit are disposed; the driver is connected with one end of the seat member opposite to the moving direction of the operation unit; the power unit has an output shaft, and the transmission unit has a transmission shaft coaxially and integrally formed with the output shaft.

2. The industrial robot as claimed in claim 1, wherein the power unit is positioned between the driver and the transmission unit.

3. The industrial robot as claimed in claim 1, wherein the transmission unit is positioned between the power unit and the driver.

4. The industrial robot as claimed in claim 1, wherein the actuator further includes a feedback unit for detecting the geometrical displacement of the output shaft of the power unit.

5. The industrial robot as claimed in claim 1, wherein the actuator further includes a feedback unit for detecting the geometrical displacement of the transmission shaft of the transmission unit.

6. The industrial robot as claimed in claim 1, wherein the actuator further has a feedback unit for detecting the geometrical displacement of the operation unit.

7. The industrial robot as claimed in claim 1, wherein the transmission shaft is a threaded rod.

8. The industrial robot as claimed in claim 7, wherein the transmission shaft is a ball threaded rod.

9. The industrial robot as claimed in claim 1, wherein the driver further includes a case disposed at one end of the seat member, at least one control button disposed within the case, and a light source disposed in the case for emitting light through the control button.

10. The industrial robot as claimed in claim 1, wherein the driver further includes a signal transmission device for connection and data transmission.
